(19) United States
(12) Patent Application Publication
(10) Pub. No.: US 2008/0285396 A1
(43) Pub. Date: Nov. 20, 2008

(54) Method and Apparatus of Formatting a Three Dimensional Optical Information Carrier

(75) Inventors: Yair Salomon, Jerusalem (IL); Ortal Alpert, Jerusalem (IL); David Livshits, Ashdod (IL)

Correspondence Address: BROWDY AND NEIMARK, P.L.L.C.;624 NINTH STREET, NW, SUITE 300, WASHINGTON, DC, 20001-5303, US

(73) Assignee: MemPile In.c c/o PHS Corporate Services Inc., Wilmington, DE (US)

(21) Appl. No.: 11/912,277

(22) PCT Filed: Apr. 20, 2006
(86) PCT No.: PCT/IL2006/000488

§ 371 Date: Aug. 4, 2008

Related U.S. Application Data
(63) Continuation of application No. 11/290,818, filed on Dec. 1, 2005.
(60) Provisional application No. 60/672,982, filed on Apr. 20, 2005.
(60) Provisional application No. 60/672,982, filed on Apr. 20, 2005.

(51) Int. Cl. G11B 7/00; G11B 3/74

(52) U.S. Cl. 369/44.26; 369/100; 369/94

(57) ABSTRACT

A method of formatting at least one optical information carrier is provided. The method is aimed at creating a plurality of formatting marks that are to be sequentially addressed when reading recording information in the carrier. The method comprises recording the plurality of formatting marks within the carrier volume in an interleaved order, thereby reducing delays in recording locally adjacent formatting marks thus reducing the entire carrier formatting time.

### FIELD OF THE INVENTION

This invention is generally in the field of optical memory devices, and relates to a method and apparatus of formatting three dimensional optical information storage carriers used for recording, reading, and erasing of information.

### BACKGROUND OF THE INVENTION

Optical storage is one of the most popular information storage methods. Some optical discs in addition to information written on them have so called “formatting” or “servo” marks, used for positioning, tracking, and writing/erasing user data and other system information.

In conventional optical discs, servo marks are embossed marks or symbols having a certain pattern that indicate the coordinates of the optical pick-up head. Knowledge of these coordinates allows synchronized information recording or reading.

WO 2005/015552, to the same applicant as the present application, discloses a formatter for inscription of marks onto a 3D translucent optical medium to enable recording and retrieval of information from the medium. The formatter includes a clamping mechanism to hold the media, and at least one optical unit calibrated to focus at least one diffraction limited spot within the medium at a respective depth therein. At least one light source is optimized for the inscription of marks, and at least one actuator moves the spot relative to the medium.

According to some standards, formatting marks are located on spiral tracks beginning at the largest recordable dimension of an optical information carrier and ending at the smallest recordable dimension or vise versa. Formatting marks are recorded by scanning an optical pick-up or recording unit (OPU) along such a spiral track. A rate determining factor for formatting is the time it takes to bring the medium to be recorded to proper location relative to the recording elements. Thus, according to the conventional technique, formatting is a time consuming process, since it takes a long time to move from one location were formatting mark(s) is/are recorded to a second location in which formatting marks are recorded.

### SUMMARY OF TILE INVENTION

There is a need in the art to facilitate formatting a three dimensional optical information carrier by reducing the required formatting time.

The main idea of the present invention is associated with the following. Formatting is especially important for multilayer storage media, such as two-photon media where information or data is recorded on hundreds of layers. The accuracy of formatting does not allow using one formatting layer for all data layers. Accordingly, such media should be supplied to the user with more than one formatted layer. As indicated above, the conventional formatting process is time consuming. Considering a 3D information carrier requiring multiple formatting layers, the use of such a conventional technique will make the formatting process even more time consuming.

Two-photon or other volumetric (3D) multilayer storage media may be monolithic, or may be composed of a number attached to each other plates. The monolithic media plate/body may have one embossed formatting layer only. Some of the plates of which the media is assembled may have an embossed formatting layer. Nevertheless, these formatting layers may not be sufficient for data recording, and additional optically recorded formatting layers have to be produced in the media. The embossed layer in such cases serves as a reference layer for subsequent optical recording of additional formatting layers.

The present invention solves the above problem by providing a novel method and apparatus for use in formatting at least one three-dimensional optical information carrier. The invention provides for fast and accurate formation of the formatting marks, enabling also concurrent formatting of multiple carriers. The invention provides for successively producing a sequence of groups of the formatting marks in the same carrier using multiple optical recording units.

According to the present invention, the formatting marks are recorded in an interleaved order, rather than in a sequential one. By this, delays of the recording of formatting marks (which is inherent in sequential recording) could be significantly reduced. The formatting marks may be configured as regular marks, oblong marks, and/or oblong and tilted marks, and may be of different controlled sizes and shapes.

It should be understood that the term “interleaved order” signifies an order of the formatting marks creation different from a sequential order in which these marks are to be addressed (scanned) when reading/recording information in the carrier. The marks that indicate a track may be of different types where each mark type forms a track indicating sub-sequence that during track reading is retrieved in sequence (with respect to itself) and in parallel to the other sub-sequences. Thus, the technique of the present invention, instead of using sequential creation of the formatting marks while scanning a laser beam along multiple spiral tracks, utilizes various types of interleaved formatting, including axial formatting (creation of marks at different depths in the carrier by fast refocusing a recording laser beam along the optical axis of an optical recording unit) and/or radial formatting (by fast reciprocating movement of a laser beam along the radii in the carrier and stepwise rotation of the carrier), or a combination of axial formatting and the scanning spot method.

The formatting marks are preferably recorded about nominal positions of nodes of a three-dimensional grid (lattice) formed by intersection between equidistantly spaced spiral (cylindrical) tracks, equiangular spaced radial planes or cylindrical sections (formed by the movement of the recording unit(s) along arcs) and recording planes (virtual layers) substantially orthogonal to the radial planes. The axes of such a grid (lattice) correspond to the radial mark position, angular mark position, and position of the mark in the carrier depth (or axial direction). The marks may be evenly spaced along each of the radii; the radii may bear an equal amount of the marks; more than one mark may be produced in the vicinity of the grid node.

Here, the expression “about nominal position of nodes” signifies that the formatting marks are located in the vicinity of said nodes, namely, the formatting marks' arrangement corresponds to the arrangement of nodes of said grid, while it should be noted that each node may contain in its vicinity a single formatting mark or a few formatting marks. The lattice structure of the grid of nodes is equivalently evident in the lattice structure of the formatting marks. The lattice structure is kept in a locality, whose size is proportional to the formatting accuracy. Also, it should be noted that the term “recording plane” used herein signifies a substantially planar surface (which may not be exactly planar, since noise or disturbance might cause the recording surface to be a slightly distorted plane).

The technique of the present invention provides for concurrently or sequentially recording a group of formatting marks, namely for recording the entire set of formatting marks by successively recording the groups of marks. This can be implemented using a single optical recording unit or multiple such units (generally a single recording beam or multiple beams).

It should also be noted that grid offsets (shifts) between groups or subgroups of layers or annular zones may intentionally be introduced resulting in respective lattice offsets, thereby differentiating between groups or subgroups of formatting marks. Controlled offsets may be predetermined or pseudo random offsets. Different types of grids may be interwoven in the same carrier. One of the advantages of such mixing is to differentiate between groups or subgroups of layers or annular zones.

The technique of the present invention allows the formatting process to have inherent limits such as limited working distance of a lens system of an optical recording unit, limited movement of the lens actuator at the required accuracy, or limited ability to accurately couple a plurality of optical recording units to record accurately about the lattice nodes. Any such limit makes it advantageous to divide the formatting infrastructure of the formatted medium into a number of groups and each group is independent in terms of formatting and formatting accuracies. This results in an optical storage medium that is formatted more efficiently and is having increased accuracy. The optical storage medium comprising a division into subgroups that are independent in terms formatting and the ability to track the formatting patterns therein.

Thus, according to one broad aspect of the invention, there is provided a method of formatting at least one optical information carrier to create a plurality of formatting marks that are to be sequentially addressed when reading recording information in the carrier, the method comprising recording the plurality of formatting marks within the carrier volume in an interleaved order, thereby reducing delays in recording locally adjacent formatting marks thus reducing the entire carrier formatting time.

According to another broad aspect of the invention, there is provided a method of formatting at least one optical information carrier to create a plurality of formatting marks a monolithic volume of the carrier that are to be sequentially addressed when reading recording information in the carrier, the method comprising: controlling formatting accuracy per predefined sub-volumes of the monolithic volume of the carrier.

According to yet another broad aspect of the invention, there is provided a 3D information carrier formed by one or more monolithic plates, the carrier having a format formed by a three dimensional grid that has localized lattice-like correlation between formatting marks. The grid can have offsets, and different types of lattices can be interwoven.

According to another broad aspect of the invention, there is provided a 3D carrier formed by one or more monolithic plates, the carrier having a format formed by groupings of a certain grid of formatting marks into independent sub-volumes.

According to yet another broad aspect of the invention, there is provided a method of formatting at least one optical information carrier to create a plurality of formatting marks that are to be sequentially addressed when reading recording information in the carrier, the method comprising arranging the formatting marks about nominal positions of nodes of a three dimensional grid configured with local substantially lattice like structure correlation.

According to yet another broad aspect of the invention, there is provided a method of formatting at least one optical information carrier, the method comprising recording a plurality of formatting marks within the carrier volume of a substantially annular cross-section, said formatting marks being arranged about nominal positions of nodes of a grid formed by intersection between equidistantly spaced cylindrical spiral tracks, equiangular spaced radial planes, and recording planes substantially orthogonal to the radial planes.

In some embodiments of the invention, the recording of formatting marks may be performed by linear reciprocating movement and rotational movement of the three-dimensional information carrier, and appropriately synchronized activation of at least one optical recording (pick-up) unit to focus a recording beam onto the carrier.

In some other embodiments of the invention, the recording of formatting marks is performed by a fast reciprocating movement of an optical recording unit along radii of the carrier (while appropriately timely producing a recording light beam) and a stepwise rotation of the carrier.

In further embodiments of the invention, the recording of formatting marks comprises rotating the carrier around its rotation axis, displacing the light beam (e.g. by moving the optical unit and/or by deflection) along a spiral track, continuously refocusing the light beam in axial direction and scanning a recording spot along the track in a direction orthogonal to the axial direction, and controllably activating the light source (laser), such that the marks are recorded on a plurality of adjacent tracks located at different layers (depth) of the carrier. Multiple laser beams (e.g. multiple optical units) may be used for recording the marks in the same carrier, such that each laser beam records marks along a segment of the spiral track and/or a depth region different from that of the other beams.

In yet other embodiments of the invention, the recording of formatting marks is performed by synchronized rotation of a plurality of the optical information carriers and rotation of the plurality of optical recording units all around a common rotation axis, and rotation of the optical information carriers around their rotation axis substantially parallel to said common rotation axis.

According to another broad aspect of the invention, there is provided a method of formatting an optical information carrier, the method comprising: providing synchronized rotation of an optical information carrier around its rotation axis, rotation of an optical recording unit around a central axis spaced-apart and substantially parallel to said rotation axis of the carrier, and rotation of the optical information carrier around said central axis, and providing controlled activation of the optical recording unit, thereby producing a set of formatting marks within the carrier volume of a substantially annular cross-section arranged in a constant angular velocity formatting pattern in the carrier.

According to yet another aspect of the invention, there is provided a method of formatting an optical information carrier, the method comprising: providing at least one information carrier and at least one optical recording unit; rotating said at least one carrier in a stepwise manner around its rotation axis and moving said at least one optical recording unit along a radius of the carrier; continuously refocusing a light beam produced by the optical recording unit in axial direction of the optical recording unit; and controllably activating a light source, such that the optical recording unit records a group of formatting marks at different layers in the carrier within the carrier volume of a substantially annular cross-section.

According to yet another aspect of the invention, there is provided a method of formatting an optical information carrier, the method comprising: providing at least one information carrier and at least one optical recording unit; rotating the carrier around its rotation axis and moving the optical recording unit along a spiral track; continuously refocusing a light beam produced by the optical recording unit in axial direction of the optical recording unit; and timely activating a light source, such that the optical recording unit records a group of formatting marks at different layers in the carrier within the carrier volume of a substantially annular cross-section.

According to yet another aspect of the invention, there is provided a method of formatting an optical information carrier, the method comprising: providing at least one information carrier and at least one optical recording unit; rotating the carrier around its rotation axis and moving the optical recording unit along a spiral track; continuously wobbling/scanning a recording spot about the spiral track; and controllably activating a light source producing said spot such that formatting marks are recorded on a plurality of adjacent tracks in the same layer in the carrier.

According to yet another aspect of the invention, there is provided a method of formatting an optical information carrier, the method comprising: providing at least one information carrier and at least one optical recording unit; rotating the carrier around its rotation axis and moving the optical recording unit along a spiral track; continuously refocusing a light beam produced by the optical recording unit in axial direction and wobbling/scanning a recording spot in lateral direction (i.e. at an angle to the track direction and the optical axis) along the track; and controllably activating a light source producing said light beam such that formatting marks are recorded on a plurality of adjacent tracks located at different layers in the carrier.

According to yet further aspect of the invention, there is provided a method of formatting a three dimensional optical information carrier, the method comprising:
providing a plurality of optical information carriers and a plurality of optical recording units; arranging carriers in a circular array around a common central axis, and arranging the optical recording units in a circular array around said common central axis in a plane substantially parallel to the plane of locations of said carriers;
operating the optical recording units and the carriers to provide rotation of the optical recording units around said common central axis such that a trajectory of optical axis of each of the optical recording units passes through the rotational axis of the carriers, rotation of each of the optical information carriers around its rotation axis, and rotation on a small angle of the plurality of optical information carriers around said common central axis; and synchronizing the rotations of the plurality of carriers with the rotation of the plurality of optical recording unit, the synchronized rotations and activation of optical recording units at proper timing generating at least one optically formatted layer with formatting marks disposed in the vicinity of nodes of a predetermined three dimensional grid.

The carriers may be rotated on an angle that compensates for a shift caused by a continuously changing radius of the spiral track in location of the marks recorded on the same spiral track. This rotational movement of the carrier around said common central axis may be replaced by a small linear movement of the carriers.

The multiple optical recording units may be used for recording simultaneously one formatting layer in at least one three-dimensional carrier. Alternatively or additionally, multiple optical recording units may record simultaneously a plurality of formatting layers in at least one carrier.

According to yet another aspect of the invention, there is provided a method of formatting an optical information carrier, the method comprising:
providing a plurality of optical information carriers and a plurality of optical recording units;
arranging the carriers such that their rotation axes reside in one direction, and arranging the plurality of optical recording units such that their optical axes are parallel to the rotation axes of the carriers;
providing synchronized rotation of each of the information carriers around its rotation axis and reciprocation of the plurality of the carriers relative to the optical recording units; wherein the synchronized reciprocating and rotational movements and activation of the optical recording units at proper timing generates at least one optically formatted layer with formatting marks disposed on nodes of a predetermined three dimensional grid.

The present invention, according to its further broad aspect, provides an apparatus for formatting at least one three dimensional optical information carrier to create a plurality of formatting marks that are to be sequentially addressed when reading recording information in the carrier, the apparatus comprising: at least one optical recording unit configured for producing and focusing a light beam onto a plane inside said at least one carrier, a support unit for supporting said at least one carrier, and a control unit configured for providing a synchronized relative displacement between said at least one carrier and said at least one light beam and to timely activate the optical recording unit to produce the recoding light beam to thereby enable recording of the plurality of formatting marks within the carrier volume in an interleaved order, thereby reducing delays in recording locally adjacent formatting marks thus reducing the entire carrier formatting time.

According to yet further broad aspect of the invention, there is provided an apparatus for formatting at least one three dimensional optical information carrier, the apparatus comprising at least one optical recording unit configured for producing and focusing a light beam onto a plane inside said at least one carrier, a support unit for supporting said at least one carrier, and a control unit configured for providing a synchronized relative displacement between said at least one carrier and said at least one light beams to record a plurality of formatting marks within the carrier volume of a substantially annular cross-section, where said formatting marks are arranged about nominal positions of nodes of a grid formed by intersection between equidistantly spaced cylindrical spiral tracks, equiangular spaced radial planes and recording planes, which are substantially orthogonal to the radial planes.

According to yet another aspect of the invention, there is provided an apparatus for formatting multiple three dimensional optical information carrier, the apparatus comprising

a) a stage mounted for movement with respect to a common central axis, and carrying a plurality of spindles mounted on the stage in a circular array around said central rotation axis, with each of the spindles having its own rotation axis and carrying a respective one of the carriers;

b) a platform mounted for rotation around said central rotation axis and carrying a plurality of optical recording units arranged on the platform in a circular array around said central rotation axis, the optical recording units having parallel to each other optical axes, respectively;

c) a synchronizing mechanism for synchronizing rotations of the spindles around their rotation axes and rotation of the optical recording units around said central axis, the synchronized rotations causing a trajectory of movement of each of the optical axes to pass through the rotation axes of each of the spindles.

The information carriers are mounted on the spindles, respectively, such that the rotation axis direction of each carrier and each spindle coincide with the rotation axis direction of the optical recording units and each rotation of the optical recording unit traces at least one radial arc on each information carrier.

The synchronizing mechanism may utilize an electro-mechanical system, which operates to synchronize the rotation of spindles with optical information carriers around their rotation axes, rotation of the optical recording units and rotation of the carriers (via rotation of the stage carrying the spindles) around the central axis. Alternatively, a linear movement of stage actuators may be used (instead of rotational movement of the stage around the central axis). A suitable controller utility is provided for timely activating the optical recording units to produce recording light beams.

According to yet further aspect of the invention, there is provided an apparatus for formatting an optical information carrier, the apparatus comprising: a plurality of spindles carrying a plurality of information carriers, respectively, and mounted on a linearly moving reciprocating table, the spindles being arranged such that rotation axes of the spindles reside in one plane; a plurality of optical recording units arranged such that optical axes thereof are parallel to the rotation axes of the spindle and reside in the same plane; a mechanism configured and operable to control the rotation and reciprocating movement of the relative to the optical recording units.

The information carriers are mounted on the spindles, respectively, such that the rotation axis of the carrier and the respective spindle coincide. The synchronized reciprocating and rotational movements of the carriers and activation of the optical recording units at proper timing generates at least one optically formatted layer with formatting marks disposed on nodes of a three dimensional grid.

### BRIEF DESCRIPTION OF THE DRAWINGS

In order to understand the invention and to see how it may be carried out in practice, preferred embodiments will now be described, by way of non-limiting example only, with reference to the accompanying drawings, in which:

FIGS. 1A to 1D are schematic illustrations of some examples of a three dimensional information carrier suitable to be used with the present invention;

FIG. 2 is a top view of schematic illustration of a three-dimensional information carrier showing the principles of formatting marks pattern formation;

FIG. 3A is a schematic illustration of a three dimensional lattice formed by optically recorded on a three-dimensional carrier formatting marks;

FIGS. 3B to 3E exemplify some details of a formatting lattice used in the present invention, where FIG. 3B shows the locations of nodes along a track and the details of a simplified formatting marks pattern; FIG. 3C shows a layer of tracks being also a layer of the lattice; FIG. 3D shows a structure of a section (or a sub-volume) of the lattice; and FIG. 3E shows a difference between the interlayer distance and the inter-node distance for a specific example of the lattice structure;

FIGS. 3F and 3G exemplify the grouping techniques of the present invention utilized in a carrier having a grid;

FIGS. 4A and 4B are schematic illustrations of one of the embodiments of formatting marks recording principles and process;

FIG. 5 is a schematic illustration of another embodiment of formatting marks recording principles and process;

FIG. 6 is a schematic illustration of a method for simultaneous optical recording of the formatting pattern by two optical pick-up units (OPUs) on two three-dimensional information carriers;

FIGS. 7A and 7B are schematic illustrations of additional embodiments of formatting marks recording principles and process;

FIG. 8 is a schematic illustration of the apparatus for optically recording the formatting pattern on a three-dimensional information carrier;

FIGS. 9A and 9B are schematic cross sections of some of the embodiments of the optical pick-up units employed in optical recording systems;

FIG. 10 is a schematic illustration of another embodiment of the apparatus for optically recording the formatting pattern on a three-dimensional optical information carrier;

FIG. 11A is a schematic illustration of yet other embodiment of the apparatus for optically recording the formatting pattern on a three-dimensional optical information carrier;

FIGS. 11B-11D are schematic illustrations of exemplary embodiments of optical recording systems useful in implementation of the axial recording method of the present invention; and

FIG. 12 is a schematic illustration of an electro-optical modulator.

### DETAILED DESCRIPTION OF THE INVENTION

The principles and execution of the method and apparatus described thereby may be understood with reference to the drawings, wherein like reference numerals denote like elements through the several views and the accompanying description of non-limiting, exemplary embodiments. The drawings are not necessarily to scale, emphasis instead being placed upon illustrating the principles of the method.

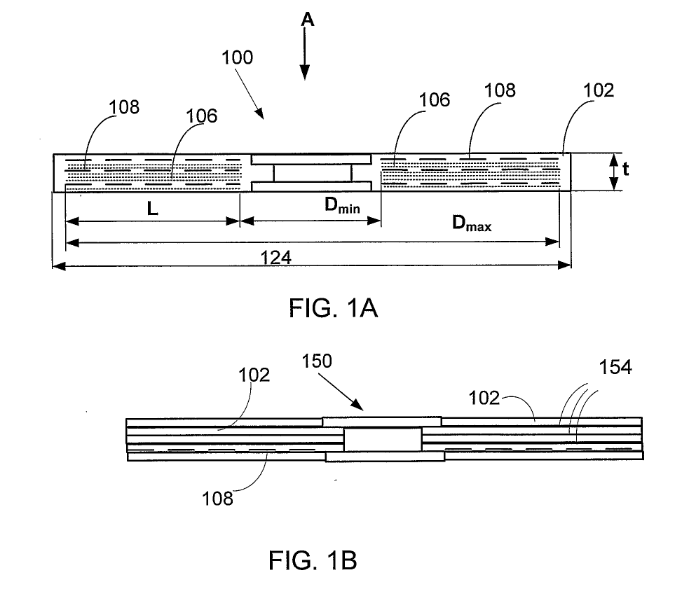

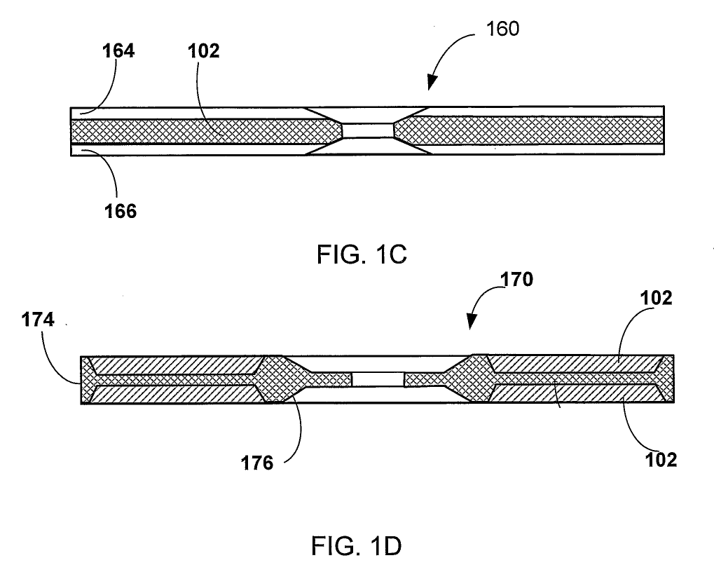

Reference is made to FIGS. 1A-1D showing schematically some examples of a three dimensional information carrier suitable to be used with the present invention. FIG. 1A exemplifies a disc-like three-dimensional optical information carrier generally designated 100. Carrier 100 may be a monolithic disc body made of a transparent or translucent polymer material 102. An active moiety, capable of changing its state from one isomeric form to another upon interaction with electromagnetic (laser) energy is bound to polymer 102. The active moiety exhibits two-photon absorption. Such a monolithic disc body is disclosed in WO 03/070689, assigned to the assignee of the present application, and may be used as a three-dimensional optical information carrier. FIGS. 1B-1D illustrate more examples of the three dimensional carrier: FIG. 1B shows a carrier 150 assembled of a plurality of plates 154 made from polymeric material 102; FIG. 1C shows a carrier 160 where polymeric material 102 is sandwiched between two transparent plates 164 and 166 forming a transparent carcass enhancing mechanical strength of the carrier; and FIG. 1D illustrates a carrier 170, where polymeric material 102 is cast into a metal carcass 174 having a hub 176.

The information or data is optically recorded on carrier 100 in practically any location, although it is convenient to record it on a plurality of “virtual” layers 106 as series of three dimensional regular, oblong or oblong and tilted data marks, such as ones disclosed in WO 2005/015552, assigned to the assignee of the present application. It should be noted that, although the formatting method is demonstrated on carrier 100, the method in its entirety is mutatis mutandis applicable to other types of carriers. A distance between layers 106 may be 10-15 micron. A thickness t of carrier 100 may be about 6 mm. In addition to optically recorded regular or oblong or oblong and tilted data marks representing the information, a pattern of servo or formatting marks is optically recorded on carrier 100. Formatting marks are recorded on a plurality of layers 108 that may be located at different depths of carrier 100 and the formatting marks may be similar or sometimes identical to data marks and may be of controlled size and length. The structure of layers 108 may be different from the structure of layers 106. In one embodiment, each data layer has its own formatted track, in another embodiment one formatting or servo layer may be sufficient to provide coordinate information to a number of data containing layers 106. Accordingly, each formatting or servo layer 108 is interspaced by at least one data-containing layer 106.

Formatting marks may be located on spiral tracks directed outwards or inwards, depending on the carrier rotation direction, beginning at the largest recordable dimension Dₘₐₓ of an optical information carrier and ending at the smallest recordable dimension Dₘᵢₙ or vise versa.

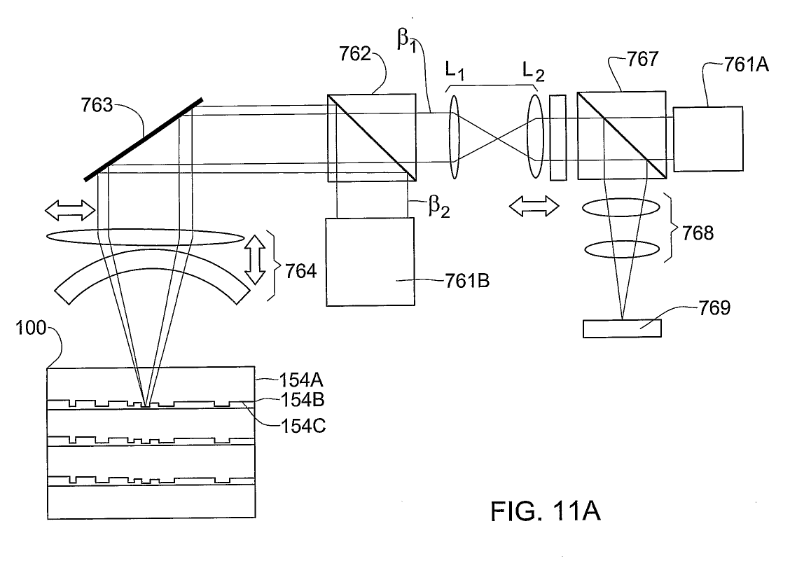

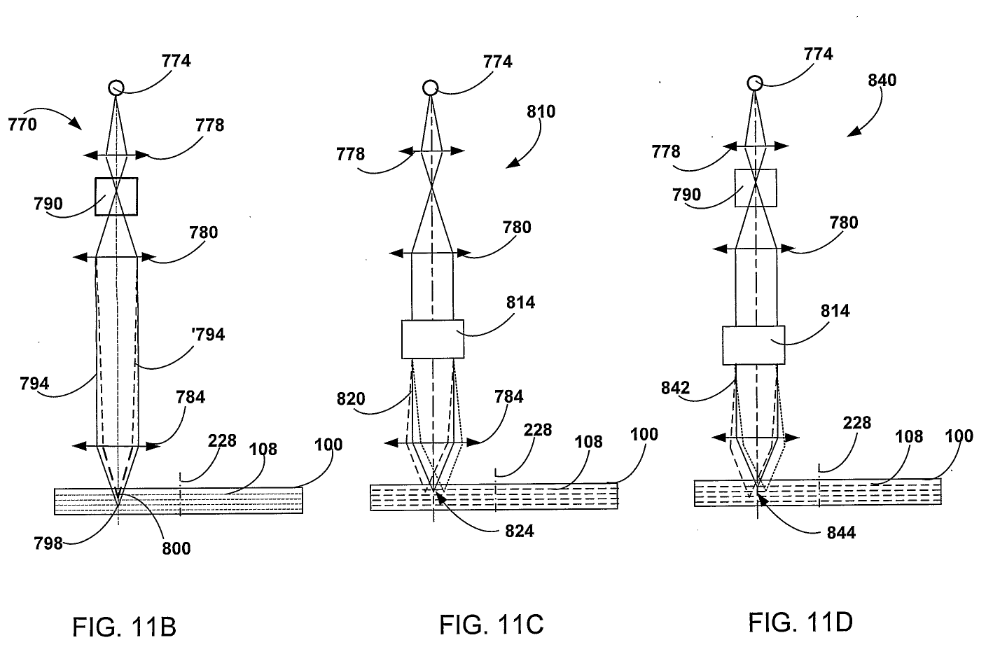

In an alternative embodiment the formatting is performed in direct reference to the reference layer. This is implemented using a suitable optical system (optical recording unit) capable of tracking the reference embossed layer by standard methods, and accurately controlling the distance between the tracking focus point and the recording focus point, which distance may be changed by accurate control of the respective beams divergence. This will be described below with reference to FIG. 11A.

The formatting process may also have inherent limits such as limited working distance of a lens system, limited movement of the lens actuator at the required accuracy or limited ability to accurately couple a plurality of recording units to record accurately about the lattice nodes. Any such limit makes it advantageous to divide the formatting infrastructure of the formatted medium into a number of groups and each group is independent in terms of formatting and formatting accuracies. This results in an optical storage medium that is formatted more efficiently and has increased accuracy. The optical storage medium thus has a division into subgroups that are independent in terms of formatting and provides for tracking the formatting patterns therein.

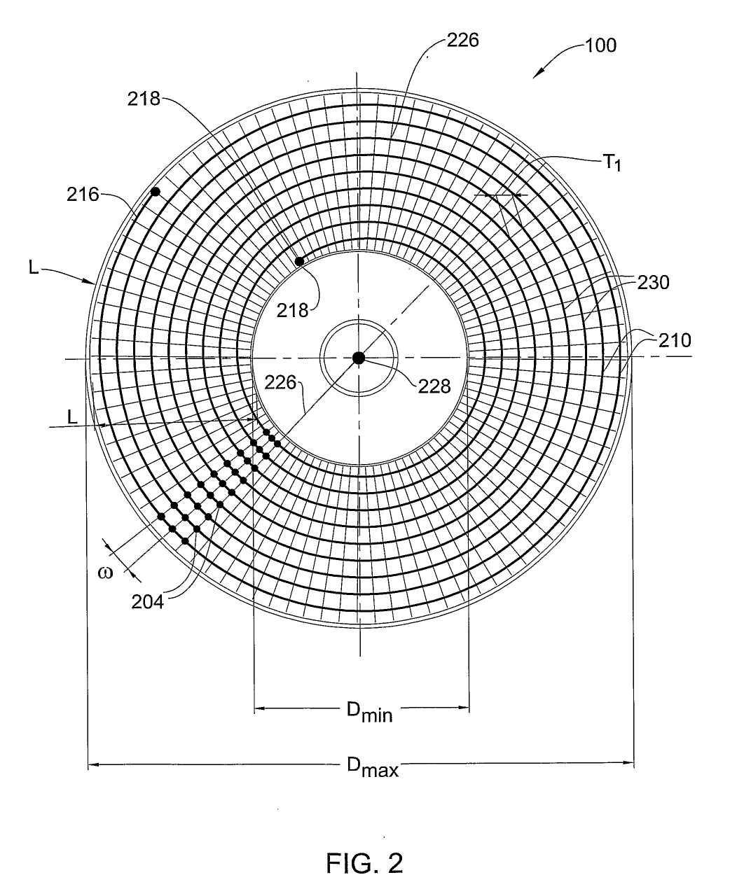

Reference is made to FIG. 2 showing a top view of a three-dimensional information carrier illustrating the position and principles of formation of a formatting marks pattern. Formatting marks 204 are arranged in a spaced apart relationship along spiral tracks 210. Adjacent tracks 210 are arranged with a certain track pitch T₁, which is the distance between the centerlines of a pair of adjacent tracks, measured in a radial direction (the so-called “radial distance”). Track pitch T₁ may be about 800 nm; other radial distances between two adjacent tracks are possible. The linear (or circumferential) distance between two successive formatting marks 204 may be about 600 micron on the outer tracks and smaller, about 230 micron, on the inner tracks, although other distances between successive marks are possible. Tracks 210 begin at annular peripheral section 216 and end at inner annular section 218. Spiral tracks 210 represent 360 degrees turn of a spiral materialized by a succession of pre-written marks recorded about the nominal center of a spiral line.

The marks are recorded on the active area of optical information carrier 100, which is bound by largest spiral track diameter Dₘₐₓ on which a spiral track begins and smallest spiral track diameter Dₘᵢₙ on which the spiral track ends. The width L of the active area would be L=(Dₘₐₓ−Dₘᵢₙ)/2. The number n of spiral tracks 210 that may be recorded on such a carrier would be:

n=L/T₁

wherein T₁ is the average pitch of the spiral tracks.

In a practical case, where the average track diameter is 81 mm (Dₘₐₓ=118 mm; Dₘᵢₙ=44 mm), there are about 37,000 tracks on a disc. The distance that the scanning head has to travel following the spiral track is about 9,415 meter.

If a radius 226 is traced from point 228, which is the rotation and geometric axis of carrier 100, to the largest diameter Dₘₐₓ of the spiral track, it will intersect all the spiral tracks existing in carrier 100. The number of intersections of a radius with the spiral tracks is equal to the number of tracks and would be

n=L/T₁

A plurality of radii 226 exiting from point 228 may be traced and spaced such as to intersect each of formatting marks 204 residing along diameter Dₘₐₓ. The angular increments ω of radii 226 may be selected such as to ensure that formatting marks 204 form a constant angular velocity servo pattern, namely formatting marks are arranged with fixed angular distances thus enabling the carrier rotation at a fixed rotation speed for all the spiral tracks, being close or far from the center of the carrier. The radii 226 contain equal number of nodes 230. The intersection points or nodes generated by the equidistantly spaced spiral tracks 210 and equiangular spaced radii 226 form a well-defined grid pattern. Accordingly, formatting marks 204 may be recorded about the nominal position (in the vicinity) of each of the nodes 230 to form a constant angular velocity servo pattern. It should be noted that a single formatting mark may be recorded in the vicinity of the respective node (in which case the number of nodes 230 is equal to the number of formatting marks present on carrier 100), or a few formatting marks may be recorded in the vicinity of the same node, e.g. being located above and/or below the node.

Thus, in some embodiments of the invention, the nodes are arranged along sections of rays (radii) along fixed angular distances were the sections of rays continue from the smallest spiral track diameter Dₘᵢₙ to the largest one Dₘₐₓ, providing one constant angular velocity for the whole carrier. Other grid patterns, meeting the requirements of constant linear velocity or constant zonal velocity servo pattern, may be provided. Smaller subsections of radii (or rays) may be used to provide a division of the carrier into annular zones each providing for a different angular distance, different linear velocity and varying data marks density.

Formatting marks may be optically recorded on carrier 100 in any location, although it is convenient to record them on a plurality of layers 108 (FIG. 1A). Within each of such layers 108, formatting marks 204 are disposed on a grid the nodes which are generated by intersection between equidistantly spaced spiral tracks 210 and equiangular spaced radiuses 226.

Formatting marks 204 being recorded on a plurality of virtual layers 108 in carrier 100, form a three dimensional lattice with axes being the radial mark position, angular mark position and position of the mark in the depth or what is called axial direction of carrier 100.

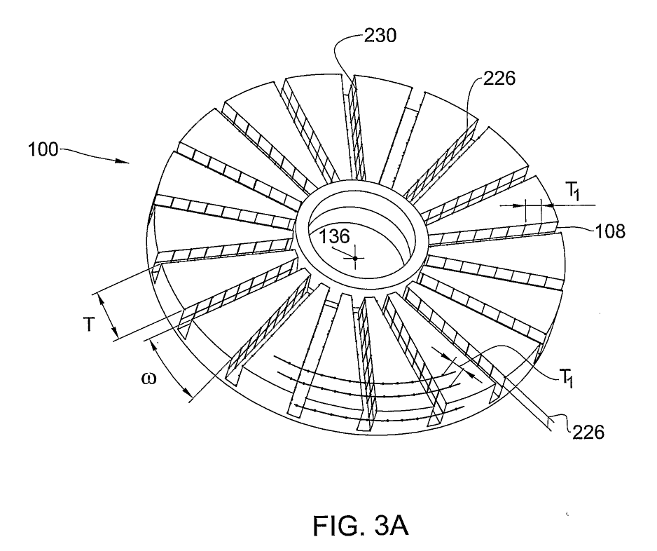

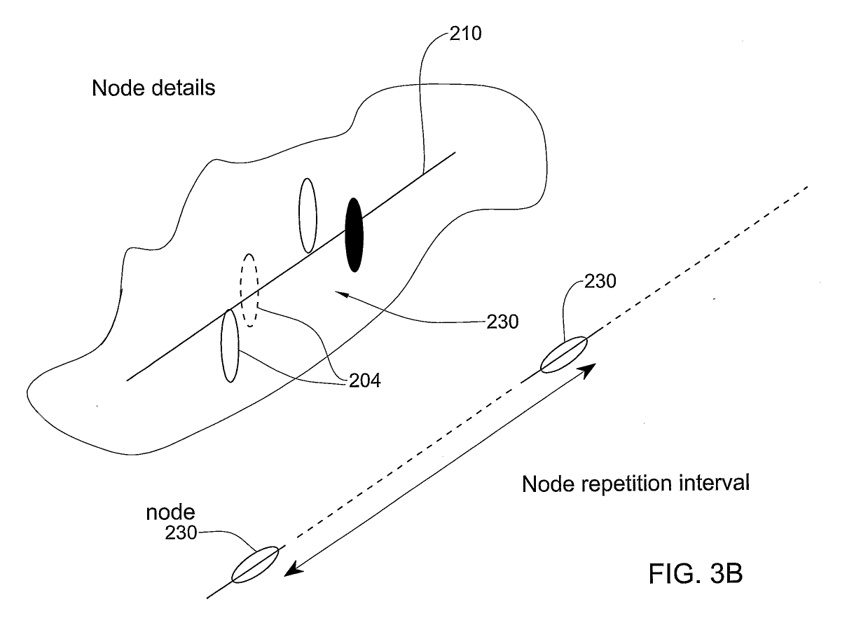

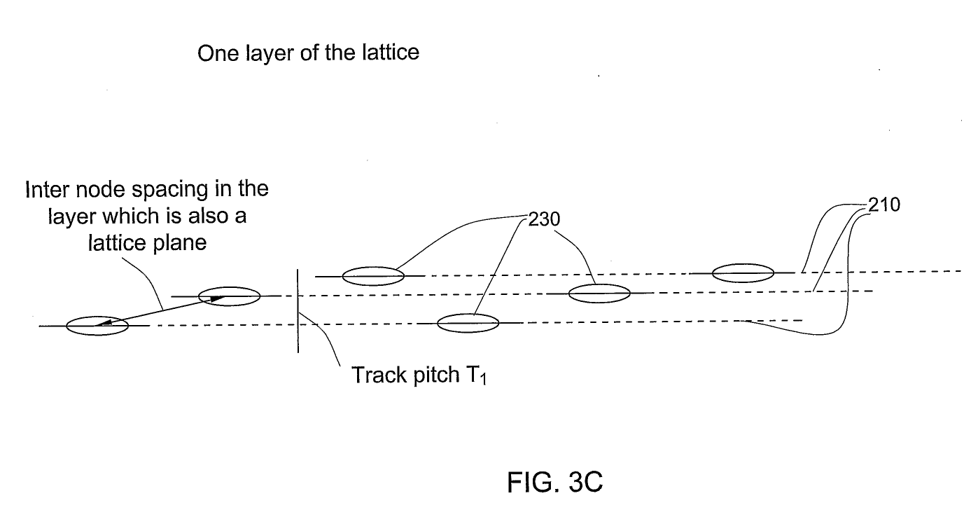

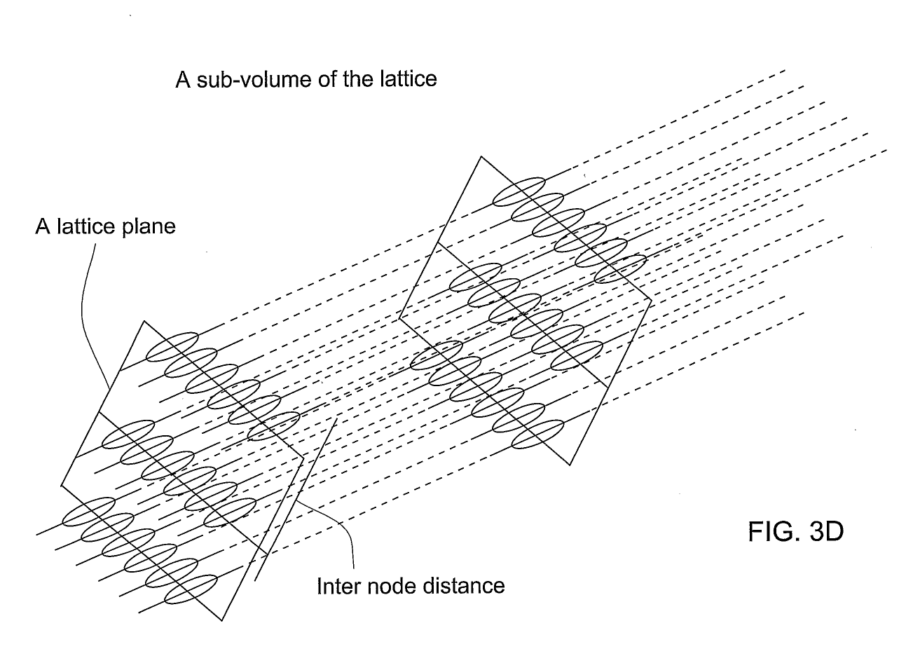

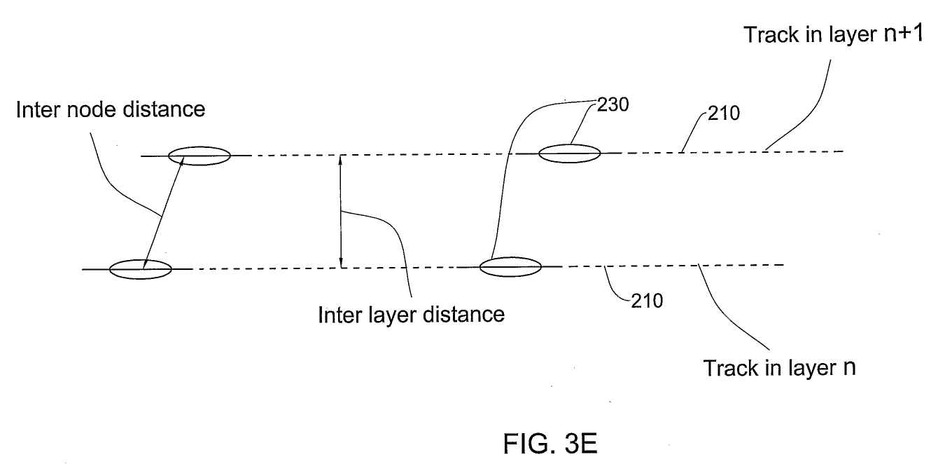

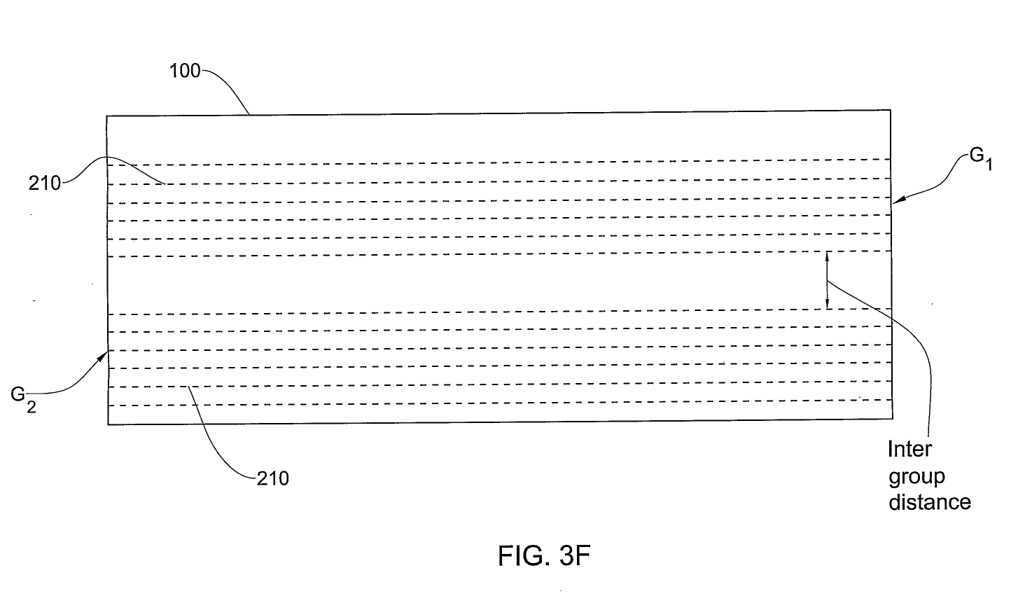

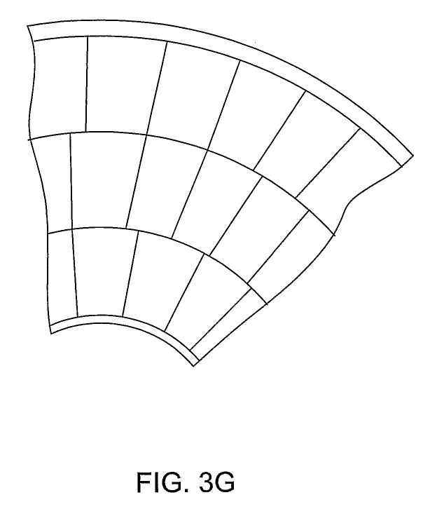

FIG. 3A illustrates the three dimensional lattice or grid formed by an arrangement of nodes 230. These nodes are intersections between equidistantly spaced (cylindrical) spiral tracks 210, equiangular spaced radial planes (radii) 226 and a plurality of recording planes 108 or virtual layers orthogonal to the radial planes 226. Formatting marks 204 are located about the nominal position of the nodes 230 of the grid, which become nodes of the lattice.

Generally speaking, formatting marks 204 are located in the vicinity of nodes 230 (e.g. above or below the respective node), such that the arrangement of formatting marks 204 corresponds to the arrangement of nodes 230. Each node may be associated with more than one (a few) formatting marks. The lattice structure of the grid of nodes is equivalently evident in the lattice structure of the formatting marks. The lattice structure is kept in a locality, whose size is proportional to the formatting accuracy. Radius of rotation 304 of an optical pick-up (OPU) device is selected such that its trajectory follows the locations of the intersections of spiral track 210 and radii 226 as will be described more specifically further below. Thus, carrier 100 of the present invention is formed with the formatting marks disposed in accordance with a three dimensional lattice nodes 230, which are intersections between equidistantly spaced (cylindrical) spiral tracks 210, equiangular spaced radial planes (radii) 226 and a plurality of recording planes 108 or virtual layers.

The present invention provides a novel formatted carrier and a carrier formatting method where the format is formed by grouping a certain grid of formatting marks into independent sub-volumes. Then principles of this concept are exemplified in FIGS. 3B-3G, where FIGS. 3B-3E illustrate the details of a formatting lattice, and FIGS. 3F-3G illustrate the grouping of a carrier with a grid.

FIG. 3B exemplifies a simple formatting patter. A node 230 of a lattice is shown, defined by an arrangement of a few spaced-apart formatting marks 204. Also, the figure shows more specifically two nodes (each being defined by such an arrangement of a few formatting marks) which are spaced from each other along a track 210 by a node repetition interval.

FIG. 3C shows more specifically a part of a layer of tracks 210 which is also a layer of the lattice. Each spiral track 210 each associated with nodes arranged along the track in a spaced-apart relationship. In the present example, the inter node spacing in the layer is different from the track to track distance (track pitch) T₁, and the natural angle of the lattice is not orthogonal to the track direction.

FIG. 3D exemplifies a structure of a section (or a sub-volume) of the lattice formed by an arrangement of nodes with respect to the lattice plane. It should be noted that an inter node distance in between the layers is not the interlayer distance but an internal feature of the lattice.

FIG. 3E exemplifies an arrangement of nodes in the vertically aligned spiral tracks in two adjacent layers. As shown, the inter node distance is different from the interlayer distance in this specific example where the lattice structure is such that tracks are recorded exactly one above the other (vertically aligned) with respect to the optical axis. This results from the axial formatting method of the present invention, as will be described further below.

FIG. 3F shows a cross section of a carrier 100. Two groups G₁ and G₂ of tracks 210 are recorded in the carrier axially spaced from each other by a certain inter group distance. The first group G₁ of tracks is recorded by a first recording unit calibrated for a first depth in the carrier, and the second group G₂ of tracks is recorded by a second recording unit calibrated for a second depth in the carrier. The inter layer distance in each group is dictated by the signal characteristics typical for the media, and light source (e.g. laser) and optics quality (e.g. numerical aperture). The inter layer distance for two photon absorption media using high numerical aperture (0.65) is typically 4-10 microns. The distance between the two groups of layers is dictated by the accuracy of formatting and the optics capabilities; typical used groups distance is 30-70 microns. Lenses used in optical storage allow focusing in a depth range of about 100 micron without the need for spherical aberration correction thereby allowing the recording of groups of 20 layers with an optical system having a simplified structure where the focusing system comprises only one lightweight lens and the system is more robust to vibrations and other disturbances.

FIG. 3G illustrates another aspect of grouping within the carrier. The figure schematically draws a top view of a section of one layer emphasizing the annular zones division of a carrier. The carrier is divided into annular zones. Each zone is formatted independently of the other zones using a radial formatting scheme, where the angular distance between the radial planes forming the lattice structure is reduced in the internal zones, thereby enabling a more uniform distance between consecutive formatting marks along a track residing in different radii of the carrier. Thus, in this specific example, the carrier includes three different zones associated with three lattice types, characterized by different locally uniform formatting marks distance or different angular frequencies.

According to the known technique, disclosed in WO 2005/015552 to the same assignee as the present application, formatting marks are recorded by moving the recording spot formed by an OPU along track 210. According to the present invention, the formatting marks are recorded in an interleaved manner, rather than in a sequential one, thus reducing delays of the recording of formatting marks which is inherent in sequential recording.

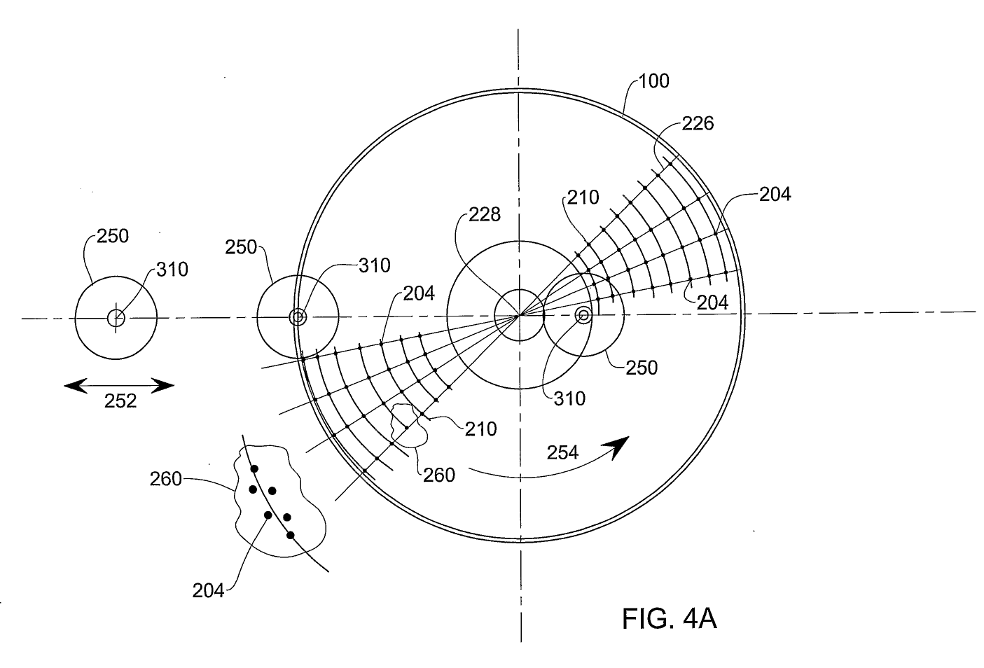

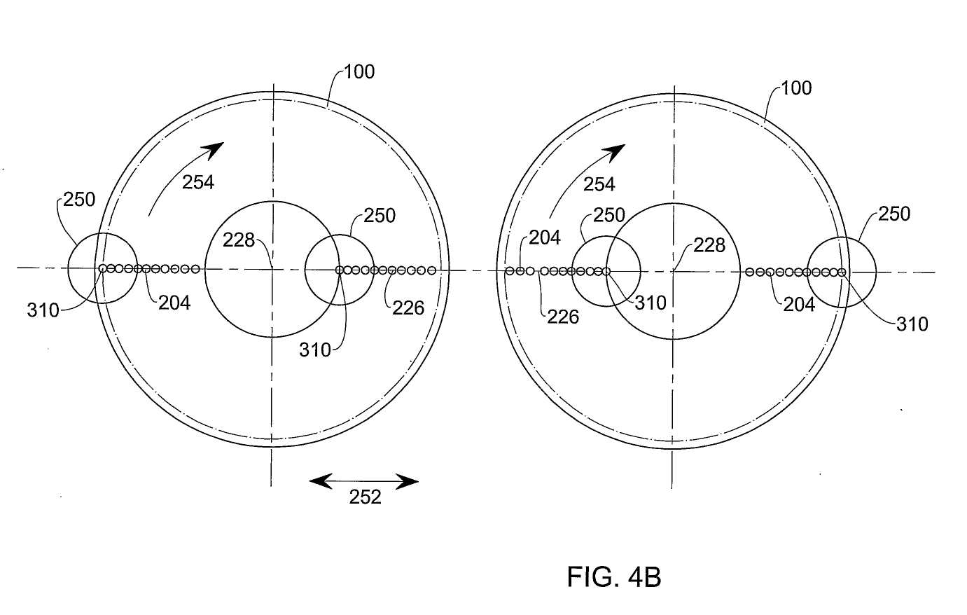

FIG. 4A is a schematic illustration of one of the embodiments of formatting marks recording principles and recording process. According to the present method of optical recording of marks 204, fast reciprocating movement (shown by arrow 252) of an OPU 250 along radii 226 and stepwise rotation of carrier 100 in the direction of arrow 254 replaces the slow rotational movement of carrier 100 and the slow scanning movement of OPU along spiral track 210. Optical pick-up unit 250 performs a reciprocating type of movement and it is activated at proper time to record marks 204. Carrier 100 is substantially static in course of the recording process.

Marks 204 are recorded in the volume of the carrier, on active area L, which for the discussed above example is about 37 mm. The number of radii traced is about 600, which means that for each layer a recording head 250 has to travel a distance of about twenty two meter only. This distance is about 430 times smaller than the distance 9,415 meter that the scanning head has to travel following the spiral track. Marks may be recorded by shorter than microsecond (100 nanoseconds) pulses. Accordingly, the carrier formatting time even at the same travel speed is much shorter. This method of formatting will be termed radial formatting.

Marks may be recorded, by activating OPU 250 at proper time, as single marks and as clusters 260 of formatting marks. For recording of clusters 260, the recording system may be equipped by an optical system that images complete clusters 260 of formatting marks 204 of appropriate configuration.

Alternatively, carrier 100 may perform both rotational (arrow 254) and reciprocating (arrow 252) movements. As shown in FIG. 4B, marks 204 may be recorded simultaneously on a plurality of carriers 100. The recording system 250 in this case may be static. The use of a static recording system simplifies optical layout design and allows for using multiple optical recording heads for writing on the same carrier. For example, two optical recording heads may record marks on diametrically opposite sides of the same carrier 100. Marks 204 are regular or oblong and tilted marks located about the nominal position of track 210. The spatial position of marks 204 may be below, above or on both sides of track 210. Marks 204 recorded on the left part of carrier 100, except for their spatial position, are a mirror image of marks 204 recorded on the right part of carrier 100 and vise versa. Each of the two OPUs 250 may be advantageously adjusted (to appropriately direct a recording light beam) to record marks on the respective part of carrier 100.

For proper recording of marks 204 in accordance with the arrangement of nodes (230 in FIG. 2) of the grid formed by intersections points between radii 226 and spiral or circular tracks 210, carriers 100 are arranged such that their rotation axes 228 are substantially parallel and rotate in the same direction. Considering the use of the plurality of optical recording units 250, they are also arranged such that their optical axes 310 are substantially parallel to each other and to the rotation axes of the carriers. As a result, planes in which the formatting marks are formed by the respective focus points of OPUs are substantially parallel planes. In such case, the synchronized reciprocating and rotational movements of carriers 100 combined with the activation of OPUs 250 at proper timing, produces optically formatted layers with formatting marks 204 disposed on (in the vicinity of) nodes 230 of the three dimensional grid. The size of the locality in which the lattice structure of the grid is kept is also dependent on this timing accuracy.

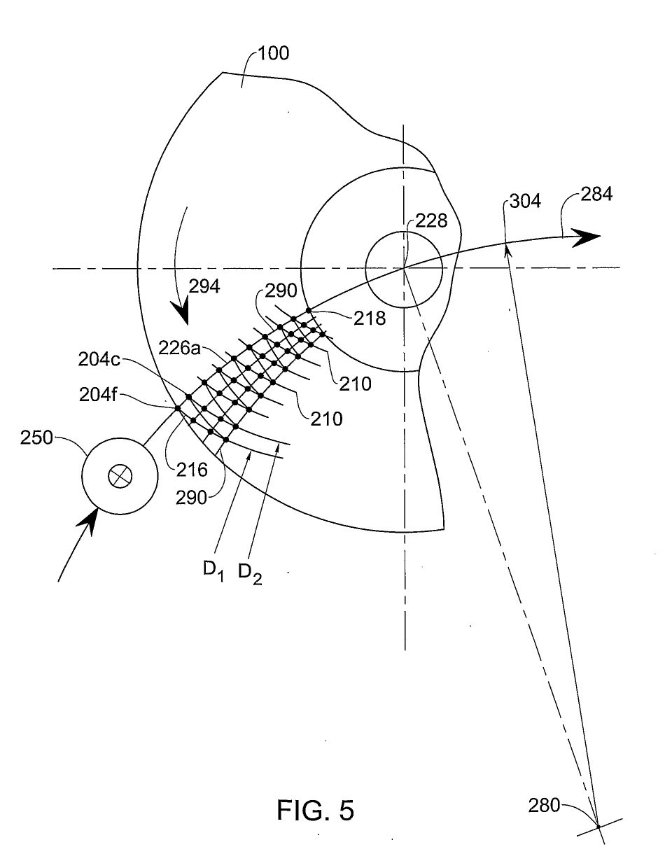

The use of continuous movement of carrier 100 and optical recording head 250 further significantly increases the throughput of the present formatting method. This is illustrated in FIG. 5 showing schematically radial formatting marks recording process of the present invention where the reciprocating linear movement of carrier 100 or OPU 250 is replaced by continuous rotation of OPU 250 and rotation of optical information carrier 100. OPU 250 rotates around a center 280 and moves with a certain trajectory 284, which in the present not limiting example passes through rotation and geometric center 228 of carrier 100. OPU 250 can thus record marks 204 that would reside on radial arcs 290. To transform or straighten arcs 290 into radiuses 226, carrier 100 is operated to perform, simultaneously with OPU 250 rotation movement, a continuously rotation around axis 228 in the direction indicated by arrow 294. The resulting location of recorded marks 204 is defined by a sum of movements: the rotational movement of OPU 250 around axis 280 and rotation of carrier 100 around its axis of symmetry 228.

A constant angular velocity servo pattern is characterized by a distance between formatting marks or symbols 204 residing on spiral tracks 210 (which are exaggerated for illustration purposes), which is gradually decreasing towards the center of the carrier along spiral track 210. To arrange the formatting marks along substantially radial lines, optical carrier 100 rotates, during each complete rotation of optical recording head 250, on an angle selected such that the rotation of the carrier compensates for a shift caused by the convexity or radial arc 284. For example, if optical information carrier 100 has 600 or 800 marks on the largest spiral track diameter and a corresponding number of radii or radial sectors, then on each complete rotation of optical recording head 250 the carrier will rotate 1/600 or 1/800 of a turn. Formatting marks 204 recording will begin with a node residing on a largest spiral track 216 and intersection of a first radius 226-a, and each next node will be located on the intersection of the next spiral track with the same radius 226-a. The recording ends with a node residing on the intersection of the same radius 226-a and a smallest diameter spiral track 218

A radius of rotation 304 of OPU 250 is selected such that its trajectory follows the locations of the intersections of spiral track 210 and radii 226. This means that all formatting or servo marks 204 (per layer) may be produced by about 600 rotations (or other number of rotations depending on the number of marks on the outer track) of the optical recording head (OPU) 250, which is at least 66 times more efficient than the 37,000 rotations required for the conventional technique of recording marks following a spiral track. Mechanical deformations, caused by the centrifugal forces and vibrational forces, limit a rotation speed of the carrier; at least 6 min may be required to format a single layer carrier by the conventional optical recording of marks at a 100 Hz rotation speed.

In addition to the discussed rotational movements of carrier 100 and OPU 250, there is a need to compensate for a continuous change in a distance between formatting marks 204 when they are recorded on the same and subsequent spiral tracks. Referring to the examples of FIGS., 2, 4, 5 and 6, the shift occurs because the diameter of spiral track 210 is continuously changing and the same number of marks 204 is recorded on each spiral track 210. For example, the recording of a mark 204-f on the largest section 216 of track 210 begins on a diameter D₁, and the last mark 204-l belonging to the same track 210 is recorded on a diameter D₂, which in this case is smaller than diameter D₁. In order to compensate for this shift, carrier 100 may slightly move along trajectory 284. It simply rotates on a very small angle around the center 280 of rotation of OPU 250 in the course of the recording process. The rotation and geometric center 228 of carrier 100 remains, however, on trajectory 284. Another method of recording the formatting marks in spiral lattice nodes is by controlled synchronization that delays the recording performed by the OPU passage over the disk so as to have a sub-track delay. More specifically, the marks containing nodes could be considered as being produced along each radius as a set of recording times. If the recording times are the same for all the radii the natural way to connect (by a track) the recorded mark containing nodes would be circles. If the nodes of radius k are delayed relative to the nodes of ray (k−1) then the nodes will be recorded a little bit towards the center, such a sequence of nodes would form an ingoing spiral. The delay can also be achieved by synchronizing the recording OPU so that a tiny delay will be systematic.

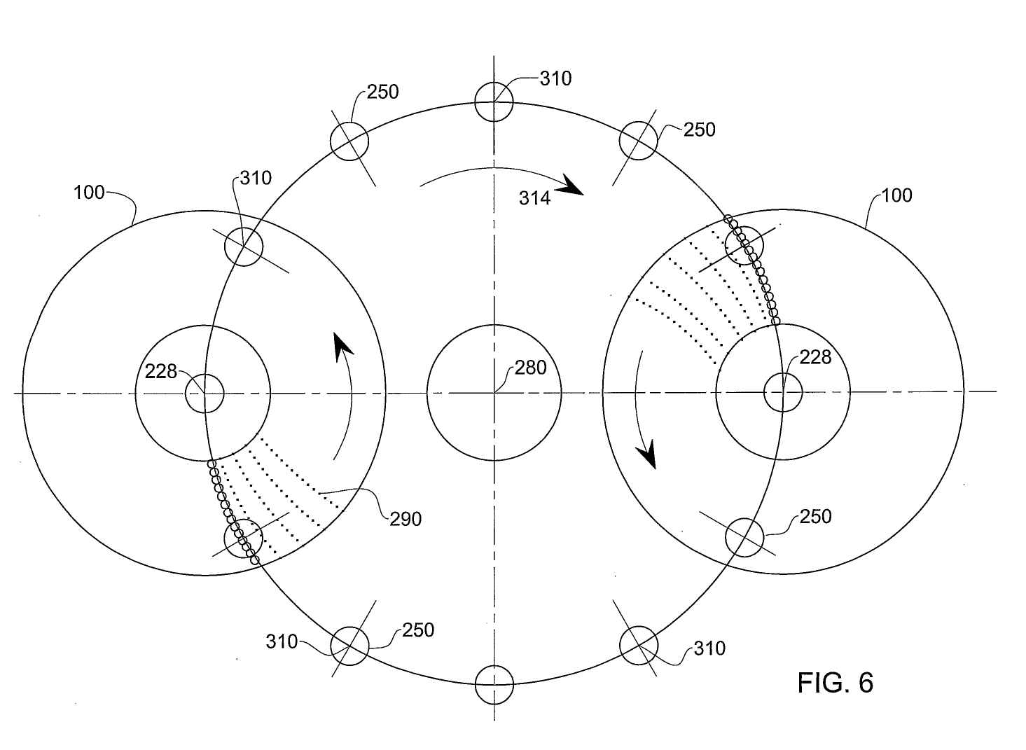

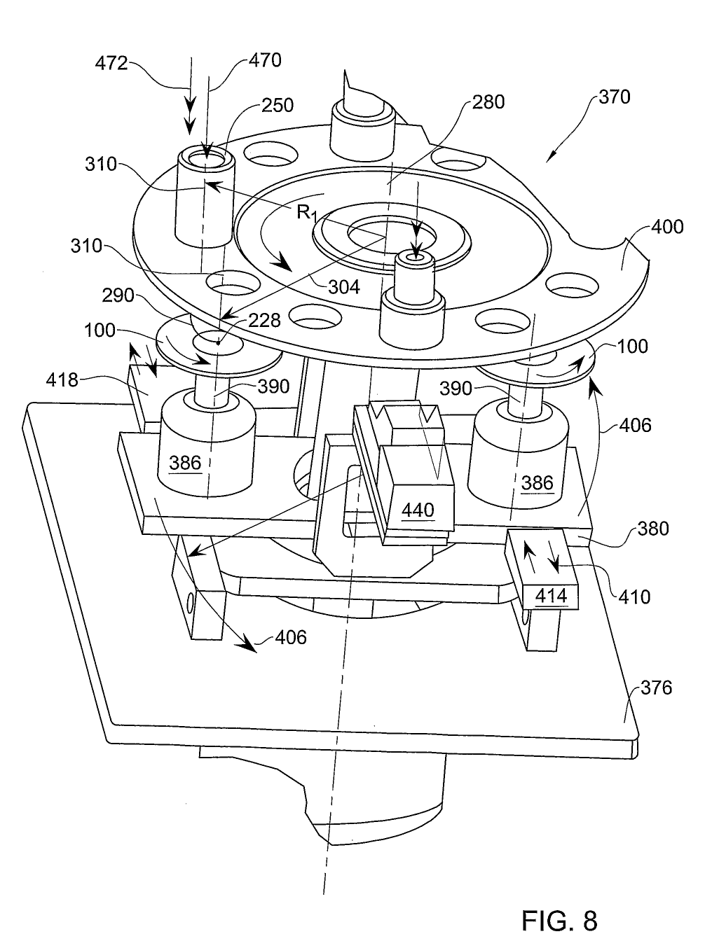

FIG. 6 illustrates a method of the present invention for simultaneous formatting of two optical information carriers 100 by a plurality of M optical recording units/heads (OPUs) 250. All the OPUs 250 are arranged for rotation about a common central axis 280. Carriers 100 are equidistantly disposed from central rotation axis 280 of OPUs 250. Considering more than two carriers, they are arranged in a circular array around avis 280. Each of carriers 100 may rotate around its own rotation axis 228. OPUs 250 rotate around axis 280 such that the trajectory of movement of an optical axis 310 of each of OPUs 250 passes through rotation axes 228 of each of the plurality of information carriers 100. This type of movement traces, on each of carriers 100, radial arcs 290 coinciding with a section of trajectory (284 in FIG. 5) on each of the plurality of optical carriers 100. Continuous and synchronized rotation of carrier 100 and OPU 250 transforms or straightens arcs 290 into radiuses 226. When OPU 250 passes above information carrier 100, a recording light source (e.g. laser diode) is activated at proper time to record formatting marks 204. As explained earlier, in order to compensate for the shift in position of the marks that occurs due to the continuously changing radius of the spiral track, the plurality of carriers 100 may in course of the recording process slightly rotate or reciprocated as will described below with reference to FIG. 8. In a similar way, the method may be scaled to record formatting marks on N carriers by M recoding heads. The formatting speed will be further increased according to the number of recording heads participating in the process

Carrier 100 may have a plurality of formatting layers (108 in FIG. 1A) with each formatting layer being on a different depth of carrier 100. The different formatting layers may be recorded by refocusing OPUs 250 or changing a distance between OPUs 250 and carriers 100. Control of the distance may be performed by a variety of means, e.g. using the technique disclosed in WO 2004/032134, to the same assignee as the present application. Each of the OPUs is tightly focused, and spherical aberration of the OPU is corrected for all refocusing path length.

Using synchronized rotation of optical information carrier 100 about its rotation axis 228, rotation of OPU 250 around common central axis 280 and rotation of the plurality of optical information carriers around rotational axis 280 produces a set of regular or oblong, or oblong and tilted servo symbols 204 of controlled size and shape forming a servo pattern. Marks 204 may be spatially disposed about the nominal location of nodes (230 in FIG. 2) of a grid formed by intersection between equidistantly spaced spiral (or circular) tracks 210 and equiangular spaced arcs 290 straightened into radiuses 226. The nodes of the lattice are thus defined by intersections between equidistantly spaced (cylindrical) spiral tracks 210, equiangular spaced radial planes (radiuses) 226 and a plurality of recording planes 108 (virtual layers) orthogonal to radial planes 226.

Depending inter alia on the carrier structure in the embodiments of FIGS. 1A-1D, one or more base formatting layers are inscribed or embossed inside the carrier. The optical medium may be formatted (i.e. arrangement of data marks) as disclosed in WO 2005/015552 to the same applicant. The optically recorded formatting pattern may be disposed about the nominal position of nodes 230 of the disclosed above lattice. The inscribed or embossed formatted layer may serve as a reference layer for optically recording additional formatting layers. The inscribed or embossed layer becomes a part of the three-dimensional lattice. Each new consecutive formatted layer is recorded while reading and tracking a layer recorded before it (referring to it), thus ensuring the correct formatting and spacing of each new layer. Nevertheless, errors may accumulate and the correlation of the formatting structure may decrease, and after a certain number of layers (groups) the procedure is reset and recording of a new group of layers related to a different reference layer begins.

In the conventional formatting schemes, the distance between the successive laser spots (i.e. a delay between successive recording events) while recording the formatting marks along the track is the same as that for the data reading, and is in the order of hundreds of microns, and the medium rotating speed limits the mark recording rate to hundreds of KHz. In the ‘radial’ recording scheme of the present invention (constituting an example of interleaved recording), the distance between consecutively recorded marks is in the order of one micron, enabling additional substantial increase in formatting density and throughput. Another method of substantially increasing the formatting throughput may be enabled by interleaving the recording of spiral subsets of the above-described three-dimensional lattice/grid.

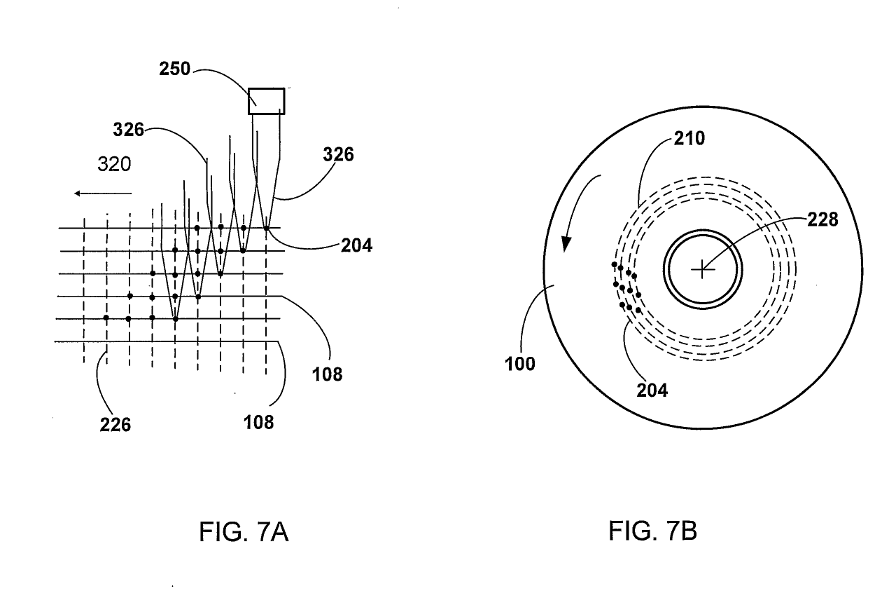

Reference is made to FIG. 7A, illustrating a method of the present invention where recording of formatting marks in carrier 100 or any other described above three-dimensional carrier is performed by fast refocusing of a recording laser beam along the optical axis of an OPU 250. The Optical axis of OPU 250 may reside (coincide) in a radial plane 226. Marks 204 may be recorded in a conventional manner following a spiral track 210. (FIGS. 2, 3, 4 and 5) or along radii 226. Carrier 100 continuously rotates in a direction shown by arrow 320, and, as OPU 250 refocuses fast to a different depth or virtual layer 108, a recording laser beam 326 performs a stepwise saw tooth like motion. As a result of the carrier rotation, marks 204 are recorded on each layer 108 in a different location in interleaved manner. However, since the shift in marks location between the layers is constant, after one complete rotation the missing in the lattice marks are filled in. In other words, in this specific example of saw tooth like motion, the axis of the lattice/grid is tilted with respect to the optical axis, such that a successively recorded subgroup of layers is not necessarily recorded in exactly the same offset as the previously recorded one although the tilt within the successive subgroup will be the same. The speed of rotation of carrier 100 and the OPU 250 refocusing time may be selected such that marks 204 are recorded on the nodes of a lattice equivalent to the above described nodes 230. This method of three-dimensional carrier formatting is termed axial formatting method.

The refocusing of OPU 250 allows placement of a formatting mark in practically any location along an optical axed 310 of OPU 250 and at different depth in carrier 100. Hence, with the axial formatting marks formation method, the marks may be recorded at micron or sub-micron depth differences from each other and from data layers. Typically, each data layer (106 in FIG. 1A) has its own formatted track 108, however when the recording depth density between the data and servo tracks is from sub-micron to few microns, one formatted layer may serve a number of data containing layers 106, for example, data layers 106 that are above and below the formatted track 108. Accordingly, the formatting throughput will increase.

FIG. 7B illustrates yet further embodiment of the invention, where a recording beam (not shown) scans about a spiral or circular track 210, ideally in a stepwise saw tooth (or raster) like motion and concurrently and synchronously records a number of formatting marks 204 on a number of adjacent tracks 210, while three-dimensional carrier 100 rotates in the direction indicated by the arrow. The scanning speed of the recording beam and the rotation speed of carrier 100 may be selected such that marks 204 are recorded on the nodes of a lattice equivalent to the above-described lattice nodes 230. It should be noted that in FIG. 7B only the nominal locations of the nodes are shown for illustrative purposes.

In a further embodiment of the invention, axial formatting is combined with the scanning spot method, and formatting marks may be recorded, for example, at three spiral radii and four depths. The marks are recorded in sequence and not concurrently, and in the interleaved order. Nevertheless, the resulting recording rate is 12 or more times higher than the rate supported by conventional methods; as a result of the interleaved order in which the marks are recorded the relative motion between the carrier and the recording unit for the recording of marks is reduced and the delay between consecutive recording events is reduced. The effective distance of motion between the recordings of marks may be tens of microns or even shorter. Axial modulation of the laser beam enables recording in a plurality of axial depths, where the method of spot scanning of the recording plane enables recording in a plurality of spiral radii. The scan is performed by moving the spot in a direction orthogonal to the OPU optical axis. The result is a 3D lattice/grid. The speed of rotation of carrier 100, scanning speed of the recording spot and OPU 250 refocusing time may be selected such that marks 204 are recorded on the nodes of a lattice equivalent to the nodes 230 of the earlier described lattices. The accuracy in which the formatting marks are recorded dictates the extent in which the lattice correlation is preserved.

Reference is now made to FIG. 8, illustrating an example of an apparatus 370 of the present invention for radial formatting in multiple three-dimensional information carriers 100. Apparatus 370 includes a pedestal 376 on which a stage 380 is assembled. Stage 380 is configured for rotation around a central axis 280 with a limited rotational capability. In A plurality of spindles 386 are mounted on stage 380 being centered around axis 280. Each of spindles 386 is capable of rotation around its own rotation axis 390. A plurality N of information carriers 100 is mounted on respective spindles 386. In the present example of FIG. 8, for the simplicity of explanation, only two information carriers 100 on their respective spindles 386 are shown. Spindles 386 may have clamping arrangements to clamp, if necessary, the carriers in the process of formatting marks recoding. Carriers 100 are mounted such that rotation axis 228 of each information carrier 100 coincides with rotation axis 390 of respective spindle 386.

A rotating platform 400 is mounted above the plane of location of information carriers 100, and is configured for carrying a plurality of optical recording systems/units (OPUs) 250 arranged in a spaced-apart relationship in a circular array. Platform 400 is associated with a driving mechanism (not shown) that drives it for rotation around its central (rotation axis) which coincides with axis 280, in a direction shown by arrow 304. The platform 400 rotation is controlled such that a trajectory (284 in FIG. 5) of movement of optical axes 310 of OPUs 250 passes through rotation axes 228 of information carriers 100. Rotation axes 228 of carriers 100 coincide with rotation axes 390 of spindles 386. OPUs 250 are appropriately associated with rotation mechanism that rotates them such that each complete rotation of every OPU 250 traces at least one radial arc 290 on each information carrier 100.

Apparatus 370 includes an electro-mechanical synchronization mechanism (not shown) configured and operable to synchronize simultaneous and continuous rotation of each of spindles 386 with the rotation of platform 400 carrying recording heads 250 such that each next rotation of optical recording head 250 traces at least one additional equidistantly angularly spaced radial arc 290 on each of the plurality of optical carriers 100. It should be noted that one OPU may format all the carriers, if the apparatus is appropriately configured and operable to enable optical and mechanical displacement between the OPU and the carriers to move the focus point accurately to every depth in the medium. The use of an arrangement of multiple OPUs (perhaps of a limited depth range) and a plurality of carriers allows for increased (factorized) formatting efficiency.

A simple relation between the rotational movement of spindles 386 and rotation of platform 400 is as follows: The rotational movements of platform 400 and spindles 386 on which information carriers 100 are mounted are synchronized such that during one complete rotation of optical recording head 250 around axis 280 (i.e. one revolution of platform 400) each spindle 386 rotates around its rotation axis 228 on an angle α determined as:

$$α = \frac{360 °}{k} \cdot M$$

where k is the number of equiangular radial planes intersecting with the recorded layer plane, and M is the number of OPUs participating in the formatting. Other relations allow for more complex recording about the nodes of the grid, basically the requirement is that a recording OPU will be able to scan along a specific radial plane for every plane intersecting the layer plane in which the recording about the nodes is required to be performed.

Concurrently, stage 380 with the plurality of spindles 386 and carriers 100 rotates on a small angle in a direction indicated by arrow 406 around axis 280 to compensate for the shift in the position of the marks recorded on the same or the next adjacent spiral track. Continuously changing a radius of the spiral tracks causes this shift. The rotation angle required for the shift compensation is very small, since a difference between the radiuses of two adjacent marks, residing on the same spiral track, is fractions of micron. Because of this, a linear movement of stage 380 may replace the rotational movement thereof. Arrows 410 indicate the direction of such a linear movement of stage 380. A stepper motor or a piezo actuator 414 acting against a flexible resistance 418 or any other piezo actuator may provide this linear movement.

Carrier 100 may have a plurality of formatting layers with each layer being on different depth of carrier 100. The different formatting layers may be recorded by refocusing OPUs 250, or in some instances changing the distance between recording systems 250 and carriers 100. Recording spot location control system 440 is provided and configured for controlling and facilitating the focusing on a proper recording layer. Spot location control may be performed by a variety of means. In some cases, recording on a non-linear optical storage medium and particularly on a medium with two-photon absorption may require use of two lasers operating at different wavelengths shown by arrows 470 and 472. As mentioned above, apparatus 370 may support recording of clusters of marks 204, associated with one or a few nodes of the grid, e.g. by using a diffractive optical element for the beam splitting into a plurality of light components focused into separate focus spots.

Three-dimensional non-linear information carriers usually have a thickness exceeding those of conventional discs and may require refocusing in excess of the range provided by conventional OPUs. Simultaneous recording on a number of carriers 100 may require synchronized refocusing of all OPUs 250 participating in the process.

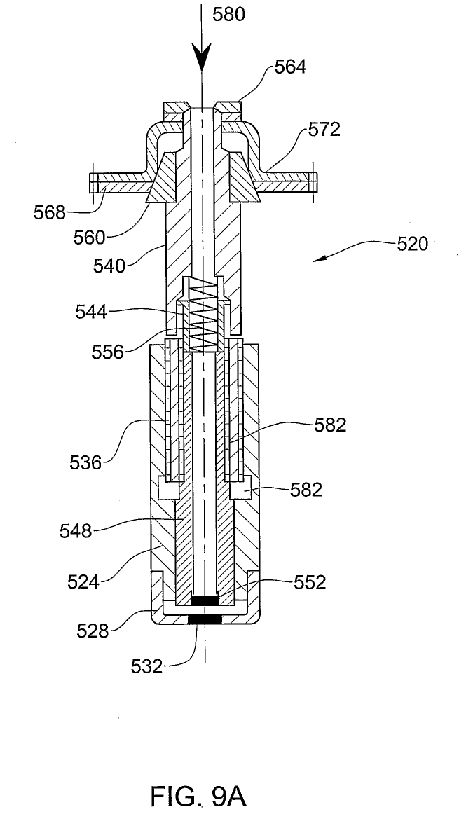

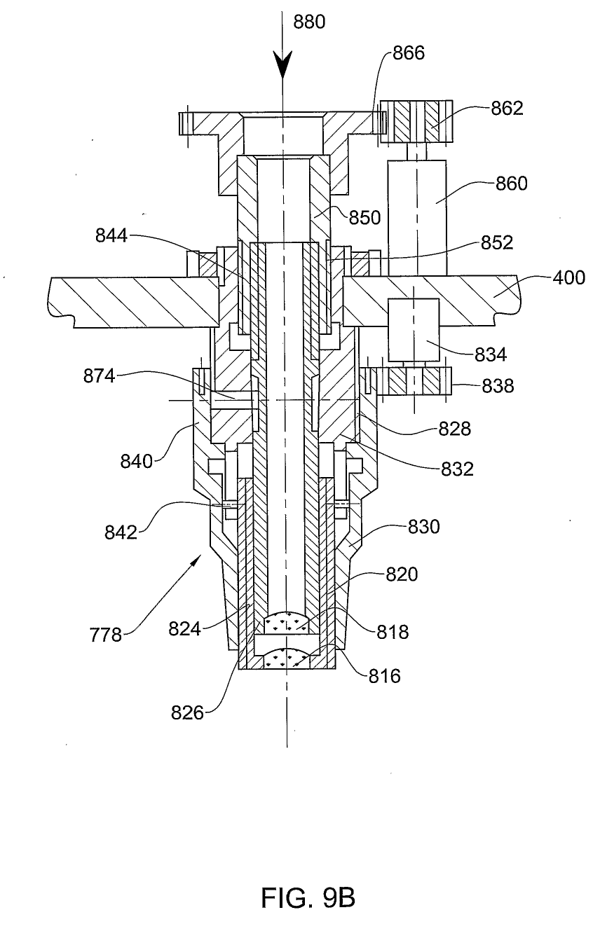

FIGS. 9A and 9B exemplify optical recording units suitable to be used in the present invention. In the example, of FIG. 9A, an OPU 520 includes an outer tubular-like housing 524 holding a cap 528 (THE FIGURE IS UNCLEAR) with a fixed lens 532. An inner surface of housing 524 has a thread 536 into which a bushing 540 is thread-in. The inner diameter surface of bushing 540 has another thread 544 with a pitch having a small difference, for example a tenth of a millimeter, with thread 536. A hollow lens holder 548 holds lens 552. The outer diameter of lens holder 548 has a thread 536 matching the thread 544 of bushing 540. When bushing 540 is rotated, lens holder 548 and lens 552 move back and forth on a very small distance defined by the difference in the pitches of threads 536 and 544. Such a mechanism is termed differential thread mechanism. Lens 552 movement changes the magnification of recording head 520. Spring 556 provides a load on lens holder 548 and eliminates any backlash that may exist in the system. The opposite end of bushing 540 has a machined section with shoulders on which a conical insert 560 sits. Nuts 564 lock and secure a pair of gears 568 and 572 mounted on insert 560 to bushing 540. When nuts 564 lock gears 568 and 572, they rotate together with bushing 540 and move lens 552 changing the magnification of recording head 520 or simply refocusing it at different depth levels of optical carrier 100. Unlocking the nuts 564 disengages gears 568 and 572 and enables manual rotation of bushing 540. Manual movement of lens 552 allows focusing the lens at a different depth or recording layers of the same carrier. Manual movement is convenient for recording head 520 adjustment purposes and in cases where the plurality of recording systems are to be adjusted to record simultaneously at different layers of the carrier. Pins/inserts 582 are used to prevent the bushing 540 rotation.

Turning back to FIG. 8, a plurality of M OPUs 520 may be mounted on platform 400. A conventional electronic or electro-mechanical servo system may be used to synchronize the refocusing of the plurality of OPUs 520 in a manner described above with reference to FIG. 9A. OPUs 520 may be adjusted to record marks simultaneously in one recording plane 108 plane (e.g. FIGS. 1A, 1B and 7A) or the same depth of carrier 100. Alternatively, each OPU of plurality of OPUs 520 may be adjusted to record marks in a different plane 108 or different depth of carrier 100 (FIG. 1A) thereby partitioning the media into subgroups formatted by different OPUs.

FIG. 9B shows an OPU 778 utilizing a double differential thread system formed by a first differential system configured for moving axially a lens 816 and a second differential system configured for moving axially a lens 818. The first differential system includes a thread 820 made on the outer surface of a housing 824 containing lens 816 and inner surface of a tubular guide 830, and a thread 828 made on the outer surface of a fixed coupler 832 and an inner diameter of the upper part of tubular guide 830. A motor 834, such as a stepper motor or a servomotor, rotates a gear 838 that engages a gear 840 made on the upper section of guide 830. Rotation of gear 838 moves lens 816 axially towards or from carrier 100 surface and to lens 818. The difference in the pitch of threads 820 and 828 determines the lens 816 movement. Pins 842 prevent rotation of lens 816. Differences in the treads pitch determine the magnitude of movement of lens 816 on each complete rotation of guide 830. It may be selected to be 0.1 mm, 0.05 mm or any other value.

The second differential system consists of thread 844 made on the outer diameter of a housing 824 containing lens 818 and an inner diameter of bushing 850, and thread 852 made on the inner diameter of fixed coupler 832 and outer diameter of bushing 850. A motor 860, such as a stepper motor or a servomotor, rotates a gear 862 that engages a gear 866 made on the upper section of bushing 850. Rotation of gear 862 moves axially the lens 818 towards or from lens 816 and changes the magnification of the OPU and a focused spot location. The difference in the pitch of threads 844 and 852 determines the lens 818 movement. Pins 874 prevent rotation of lens 818. Synchronized movement of lenses 816 and 818 changes the magnification of the OPU and moves a focused spot within carrier 100 with submicron accuracy and a high speed. Arrow 880 indicates propagation direction of recording/reading laser radiation.

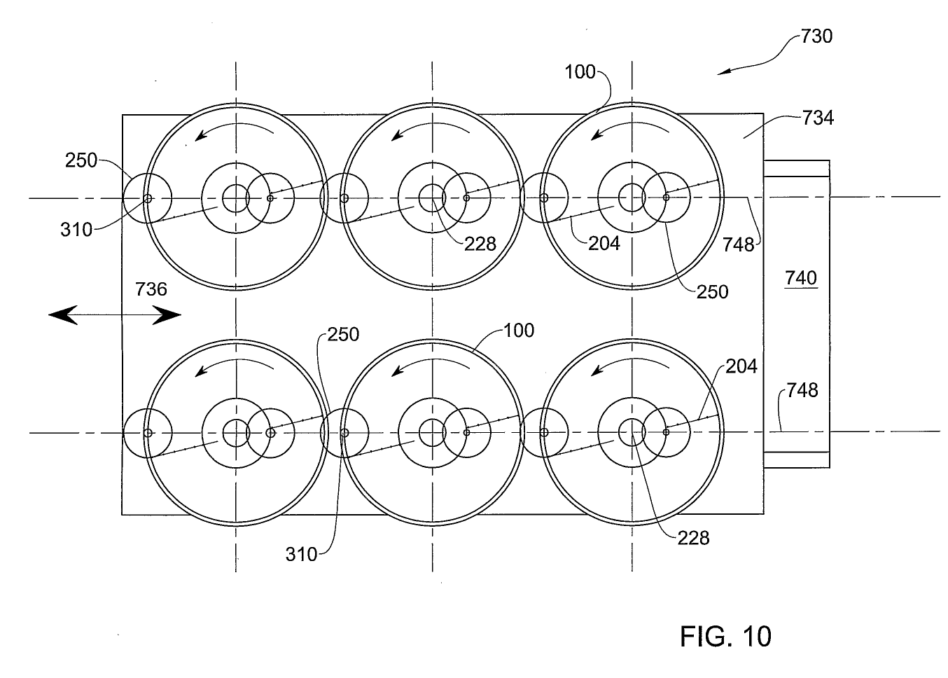

Reference is made to FIG. 10 schematically illustrating another embodiment of the apparatus of the present invention for radial optical recording of the formatting pattern in a three-dimensional information carrier. In this example, relative displacement between the OPUs and the carriers is achieved by the movement of carriers with respect to stationary mounted OPUs. Apparatus 730 includes a table or frame 734 on which a plurality of spindles (similar to spindles 386 of FIG. 8) is mounted. A plurality of carriers 100 is mounted on the spindles such that rotation and geometric axis 228 of each carrier coincides with rotation axis of the respective spindle. Table 734 moves back and forth (as indicated by arrows 736) on a guide 740. Multiple recording heads 250 (or similar 520, 778 of FIGS. 9A and 9B) are mounted on a static support (not shown), such that their optical axes 310 intersect trajectory 748 on which rotation and geometric centers (axis 228) of plurality of carriers 100 are located.

FIG. 11A exemplifies the optical layout of a recording apparatus 760 of the present invention for recording formatting marks in a carrier 100, which in the present example is formed by monolithic plates 154A with embossing 154B and adhered to each other by adhesive material layers 154C. Apparatus 760 includes a first light source 761A producing a first electro-magnetic recording radiation beam B₁, such as a laser diode emitting the radiation at a first wavelength, and a Keppler type beam expander consisting of lenses L₁ and L₁. The system further includes a second source 761B of collimated electro-magnetic radiation. Second source 761B may simultaneously provide recording/reading radiation beam B₂ of second wavelength which may be different from the first wavelength. A beam combiner 762 of any suitable type is appropriately accommodated to combine beams B₁ and B₂ into one coaxial beam. For explanation purposes, beams B₁ and B₂ after the combiner are shown as separate beams. A deflecting mirror 763 directs the combined beam to carrier 100. Beam B₁ and beam B₂ are focused at different depths within carrier 100 by a corrected for spherical aberration recording optics 764, such as one described in WO 2004/032134 to the same applicant. One of the lenses e.g., lens L₁, of the beam expander may be axially moved changing the divergence of the collimated beam. This action changes the location of focused spot 765 of first beam B₁ moving it from one formatted layer to the other formatted layer within the same plate of between the plates. Thus, a change in the distance between the tracking focus point and the recording focus point may be caused by a change of the distance between the lens pair. A beam combiner 767 directs the outcoming reflectance to lens 768 which focuses it on a detector 769, which may be a position sensitive detector. The latter provides information on the position of laser beam B₂ on a particular recordable material plate, with respect to an embossed surface. A spot 766 formed by second beam B₂ is the recording spot. The location of the formatting marks recording is controlled by accurate control of the distance between lenses L₁ and L₂ and control of the other optical elements in the optical path.

FIGS. 11B-11D are schematic illustrations of optical recording systems useful in implementation of the axial marks recording method and wobbling marks recording method. System 770 includes a source 774 of electro-magnetic recording radiation, such as a laser diode, a Keppler type beam expander consisting of lenses 778 and 780 and corrected for spherical aberration recording optics 784 (only shown schematically), such as one described in WO 2004/032134 to the same applicant. An electro-optical refractive index modulator 790 modulates divergence of a recording beam 794. Modulator 790 may be inserted in practically any point between lenses 778 and 780. The magnitude of voltage supplied to electro optic modulator 790 determines collimation level or divergence of beam 794 and effective depth of point of focus of the recording optics 784. For example, voltage V₁ may produce a recording beam 794 having first divergence and voltage V₂ may produce a recording beam 794′ having second divergence. Beam 794 having first divergence is focused at recording depth 798 in carrier 100 and beam 794′ having second divergence is focused at recording depth 800 in carrier 100. Increase of beam divergence moves the light spot in axial direction into the depth of carrier 100. The transition from recording depth produced by beam divergence 794 to recording depth produced by beam divergence 794′ may be a continuous one, and accordingly formatting marks may be recorded at any depth and at a distance of fraction of micron from each other. The beam expander has to be corrected for spherical aberrations caused by the introduction of electro-optical modulator 790, which can be implemented using any known in the art technique.

FIG. 11C illustrates an additional embodiment of the optical recording system useful in implementation of the recording method. System 810 has an electro optical or acousto-optical modulator 814 inserted in the optical path of a recording laser beam 820. Activation of modulator 814 scans or wobbles laser beam 820 in the direction orthogonal to the optical axis of system 810 and carrier rotation axis 228. OPU 784 forms a plurality of focused recording spots 824 which may be recorded on adjacent spiral tracks. Optical scanning methods are well known in the art and can be perform in high frequency by various optical elements. A scheme of one embodiment of an electro-optic modulator only is provided for the sake of clarity of disclosure.

FIG. 11D illustrates an additional embodiment of the optical recording system useful in implementation of the recording method. System 840 is a combination of systems 770 and 810. It has a modulator 790 and a modulator 814 inserted in the optical path. OPU 784 focuses a recording laser beam 842 into a plurality of recording spots 844. Spots 844 are recorded on different tracks and at different depths. This method of recording supports recording of indeed large clusters of marks 204.

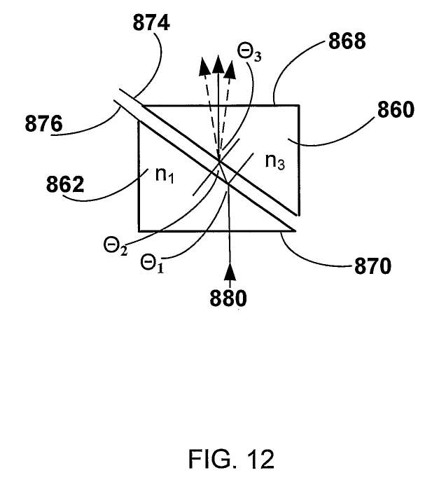

FIG. 12 illustrates an electro-optical modulator, which is a set of two prisms 860 and 862 of matching refractive index, separated by a small air gap where surfaces 868 and 870, 874 and 876 are parallel respectively and coated by anti-reflective coatings. One of the prisms is made of electro-optically active material such as doped Lithium Niobate crystal. Electrodes on upper and lower sides of the prism (not shown) supply alternating voltage on the crystal modulating its refractive index. An incident beam 880 enters prism 870 and impinges on its surface 876 at angle Θ₁. Beam 880 after emerging from prism 870 and passing through said air space enters prism 860 at an angle Θ₂. As a result of the index modulation of prism 860, beam 880 changes its outgoing angle Θ₃ according to Θ₃=a sin (n₁/n₃* sin(Θ₁), where n₁ and n₃ are refractive indices of prisms 870 and 860 materials. It should be noted that the modulation angle that is required is very small, since the distance between two adjacent tracks is about a micron and certain small ‘in-plane’ offset of the servo marks relative to the nominal spiral may exist. Recording of three spirals in parallel for example, requires a peak to peak movement of the focused spot of about 2 microns. The focal length of the focusing element is typically 3 mm, for this peak to peak angle change is less than 0.04 degrees.

Upon completion of the carrier optical formatting process, formatted three-dimensional optical carriers may undergo a type of quality control. The main parameters, subject to verification at the quality control process are: a) the axial distance between the formatted layers; b) parallelism of the formatted layers to each other and at least one of the surfaces of the disc; c) accumulated axial position deviation error of the layers; d) distance between formatting marks on each layer and differences, if such exist, in the distance between the marks recorded on different layers; e) distance between the first surface of the disc and first recorded layer; f) distance between the last surface of the disc and last recorded layer.

While the exemplary embodiment of the present method has been illustrated and described, it will be appreciated that various changes can be made therein without affecting the spirit and scope of the method. The scope of the method, therefore, is defined by reference to the following claims:

1-63. (canceled)

64. A three-dimensional information carrier having one or more monolithic plates, each of the monolithic plates comprising a structure including a three-dimensional grid of formatting marks arranged in a spaced-apart relationship within a volume of the plate, said structure comprising spaced-apart sub-volumes each containing one or more groups of the formatting marks arrangement and being independent from the other sub-volumes in terms of formatting and requirement for tracking the formatting marks arrangement therein.

65. The carrier of claim 64, wherein said three-dimensional grid is configured with a localized lattice-like correlation between the formatting marks.

66. The carrier of claim 64, wherein the formatting marks are arranged about nodes of said grid formed by intersection between equidistantly spaced cylindrical spiral tracks, equiangular spaced radial planes and recording planes, which are substantially orthogonal to the radial planes.

67. The carrier of claim 66, wherein said formatting marks are recorded along the radii in the vicinity of said nodes of the grid, the formatting marks being evenly spaced along each of the radii and each of the radii bearing an equal amount of the marks.

68. The carrier of claim 66, wherein more than one formatting mark is recoded in the vicinity of each node of the grid.

69. The carrier of claim 64, wherein the group has one of the following configurations: (i) comprises the formatting marks located at different layers in the carrier; (ii) comprises the formatting marks located on a plurality of adjacent tracks in the same layer in the carrier; and (iii) comprises the formatting marks located on a plurality of adjacent tracks at different layers in the carrier.

70. The carrier of claim 64, comprising predetermined or pseudo random offsets between the groups resulting in respective lattice offsets.

71. The carrier of claim 64, comprising predetermined or pseudo random offsets between subgroups of layers or annular zones of the same group resulting in respective local lattice offsets, thereby enabling differentiating between the subgroups of layers or annular zones.

72. The carrier of claim 64, comprising different types of the three-dimensional grids.

73. The carrier of claim 64, wherein said sub-volumes are produced by a formatting process having inherent limits of at least one of the following: a working distance of a lens system of an optical recording unit, a limited movement of an actuator of a lens of an optical recording unit at a required accuracy, and a limited ability to accurately couple a plurality of optical recording units to record accurately about the lattice nodes.

74. The carrier of claim 64, comprising recorded data marks representing information stored in the carrier.

75. The carrier of claim 64, wherein formatting marks comprise data marks.

76. The carrier of claim 74, wherein said data marks include regular or oblong or oblong and tilted data marks.

77. The carrier of claim 74, wherein the formatting marks are similar in shape to the data marks.

78. The carrier of claim 64, comprising at least one reference layer inscribed or embossed inside the carrier, said reference layer serving as at least one base formatting layer for producing additional formatting layers.

79. The carrier of claim 78, wherein the different groups of the formatting marks correspond to a recording procedure based on the different reference layers.

80. The carrier of claim 64, wherein the groups are axially spaced from each other by a certain inter group distance.

81. The carrier of claim 64, wherein the groups present different annular zones of the carrier.

82. The carrier of claim 81, wherein an angular distance between radial planes forming a lattice structure is smaller in the internal zones, thereby enabling a more uniform distance between consecutive formatting marks along a track residing in different radii of the carrier.

83. The carrier of claim 81, comprising a plurality of the zones associated with different lattice types characterized by different locally uniform formatting marks distance or different angular frequencies.

84. A method of formatting at least one optical information carrier to create a plurality of formatting marks that are to be sequentially addressed when reading recording information in the carrier, the method comprising recording a plurality of formatting marks within a carrier volume in an interleaved order including at least one of axial formatting and radial formatting, thereby reducing delays in recording locally adjacent formatting marks thus reducing the entire carrier formatting time.

85. The method of claim 84, comprising dividing the monolithic volume of the carrier into predefined sub-volumes and controlling accuracy of the formatting of the carrier per said sub-volumes.

86. The method of claim 84, comprising arranging the formatting marks being recorded about nominal positions of nodes of a three dimensional grid configured with local substantially lattice like structure correlation.

87. The method of claim 84, wherein said nodes of the grid are formed by intersection between equidistantly spaced cylindrical spiral tracks, equiangular spaced radial planes and recording planes, which are substantially orthogonal to the radial planes.

88. The method claim 84, wherein said recording of the formatting marks comprises producing a set of the formatting marks forming a constant angular velocity formatting pattern.

89. The method of claim 84, wherein the plurality of optical recording units record simultaneously one or a plurality of formatting layers in at least one three-dimensional carrier.

90. An apparatus for formatting at least one three dimensional optical information carrier to create a plurality of formatting marks that are to be sequentially addressed when reading or recording information in the carrier, the apparatus comprising: at least one optical recording unit configured for producing and focusing a light beam onto a plane inside said at least one carrier, a support unit for supporting said at least one carrier, and a control unit configured for providing a synchronized relative displacement between said at least one carrier and said at least one light beam and to timely activate the optical recording unit to produce the recoding light beam to thereby enable recording of the plurality of formatting marks within the carrier volume in an interleaved order including at least one of axial formatting and radial formatting, thereby reducing delays in recording locally adjacent formatting marks thus reducing the entire carrier formatting time.

91. The apparatus of claim 90, wherein the control unit is configured and operable to divide the monolithic volume of the carrier into sub-volumes and control accuracy of the formatting of the carrier per said sub-volumes.

92. The apparatus of claim 90, configured and operable to produce an arrangement of said formatting marks about nominal positions of nodes of a three dimensional grid configured with at least one local substantially lattice like structure correlation.

93. The apparatus of claim 90, configured and operable to produce said formatting marks within the carrier volume of a substantially annular cross-section, where said formatting marks are arranged about nominal positions of nodes of a grid formed intersection between equidistantly spaced cylindrical spiral tracks, equiangular spaced radial planes and recording planes, which are substantially orthogonal to the radial planes.
